(19) United States
(12) Patent Application Publication
(10) Pub. No.: US 2014/0085352 A1
(43) Pub. Date: Mar. 27, 2014

(54) STEREOSCOPIC DISPLAY WITH IMPROVED VERTICAL RESOLUTION

(71) Applicant: Erno Hermanus Langendijk, Eindhoven (NL)

(72) Inventor: Erno Hermanus Langendijk, Eindhoven (NL)

(73) Assignee: KONINKLIJKE PHILIPS N.V., EINDHOVEN (NL)

(21) Appl. No.: 14/119,921

(22) PCT Filed: May 25, 2012
(86) PCT No.: PCT/IB2012/052629

§ 371 Date: Nov. 25, 2013

(30) Foreign Application Priority Data
Jun. 1, 2011 (EP) 11168440.3

(51) Int. Cl. G09G 5/10

(52) U.S. Cl. CPC G09G 5/10
USPC 345/690

(57) ABSTRACT

A pixel based 3D display (10) comprising a display panel (11), a striped polarizer (12) and a display controller (15). The display panel (11) comprises a plurality of pixels (41, 42) arranged in rows and columns, each pixel (41, 42) comprising at least four sub-pixels having different colors, the sub-pixels being arranged in two sub-rows and at least two sub-columns, the arrangement of the two sub-rows of two adjacent pixels in the same row being interchanged. The striped polarizer (12) overlays the display panel (11) and comprises stripes (13, 14) of transparent polarizing material, the stripes (13, 14) being arranged in an alternating pattern of left eye stripes (13) and right eye stripes (14), wherein the left eye stripes (13) are arranged for converting light to a first polarization and are overlaying one sub-row of the two sub-rows and wherein the right eye stripes (14) are arranged for converting light to a different second polarization and are overlaying the other sub-row of the two sub-rows. The display controller (15) is arranged for using sub-pixel rendering for controlling a light output of the pixels in accordance with a 3D image to be displayed.

### FIELD OF THE INVENTION

This invention relates to a pixel based 3D display comprising a display panel, a striped polarizer and a display controller. The display panel comprising a plurality of pixels arranged in rows and columns, each pixel comprising sub-pixels having different colors. The striped polarizer overlays the display panel and comprises stripes of transparent polarizing material, the stripes being arranged in an alternating pattern of left eye stripes and right eye stripes, wherein the left eye stripes are arranged for converting light to a first polarization and the right eye stripes are arranged for converting light to a different second polarization. The display controller controls a light output of the pixels in accordance with a 3D image to be displayed.

### BACKGROUND OF THE INVENTION

In most color displays, a pixel consists of three sub-pixels, a red one, a blue one and a green one. In short, this color combination is called RGB. With these three colors, the display adapter is able to reproduce a broad array of colors in the visual spectrum. For example, the display adapter may be able to convert 24-bit or 32-bit color values to drive voltages for the separate sub-pixels. Together, the three sub-pixels produce light with the specified color value. The light coming from the display panel typically has one polarization, but may also have an undefined or mixed polarization.

In a striped polarizer based 3D display, a patterned optical film (also called patterned retarder or striped polarizer) is attached on the surface of the LCD. The striped pattern results in alternating rows of pixels of the LCD being in different polarization states (see FIG. 2). The two polarization states can be linear (two perpendicular directions) or circular (two opposite rotations; left handed circular or right handed circular). The circular polarization solution is most common, because it is less sensitive to the viewer's head tilt. The odd and even rows of the LCD show the content for the left and right eye (or vice versa). The user wears polarized glasses with one state of polarization for the left eye and the other polarization state for the other eye. One polarization filter filters out the light with the first polarization and the other lens filters out the light with the second polarization. As a result the user will only see light from half of the pixel rows with his left eye and light from the other half of the pixel rows with his right eye. In the striped polarizer based 3D display, this effect is employed to offer different images to the different eyes. Both images show the same scene, but from a slightly different viewpoint. In the user's brain this stereoscopic pair of images is combined which provides a 3D perception.

It is an advantage of this type of 3D displays that without the use of the polarized glasses, it can still be used as a high resolution, full color 2D display when normal 2D content is put on the LCD. However, when switching to 3D mode, only half of the pixel rows can be used for creating a single image (left or right). Consequently, half of the vertical resolution is lost. This loss of resolution could be compensated by providing twice the amount of pixels, but that would make the display more expensive.

### OBJECT OF THE INVENTION

It is therefore an object of the invention to provide a striped polarizer 3D with an improved vertical resolution.

### SUMMARY OF THE INVENTION

According to a first aspect of the invention, this object is achieved by providing a pixel based 3D display comprising a display panel, a striped polarizer and a display controller. The display panel comprises a plurality of pixels arranged in rows and columns, each pixel comprising at least four sub-pixels having different colors, the sub-pixels being arranged in two sub-rows and at least two sub-columns, the arrangement of the two sub-rows of two adjacent pixels in the same row being interchanged. The striped polarizer overlays the display panel and comprises stripes of transparent polarizing material, the stripes being arranged in an alternating pattern of left eye stripes and right eye stripes, wherein the left eye stripes are arranged for converting light to a first polarization and are overlaying one sub-row of the two sub-rows and wherein the right eye stripes are arranged for converting light to a different second polarization and are overlaying the other sub-row of the two sub-rows. The display controller is arranged for using sub-pixel rendering for controlling a light output of the pixels in accordance with a 3D image to be displayed.

With the display according to the invention the problem of the reduced vertical resolution is solved using a special combination of modifications to the known striped polarizer 3D display. The first modification is the use of at least four colors instead of three. For example, the RGB sub-pixels are supplemented with a fourth yellow (Y), white (W) or cyan (C) sub-pixel. Alternatively, five, six or even more colors may be used. The use of four sub-pixels is already known from, e.g., the Sharp Quattron televisions wherein each pixel comprises four vertically striped RGBY sub-pixels. In such displays the additional color is used to enhance the color representation and not to improve the vertical resolution in 3D mode. It is to be noted that a 3D version of the Sharp Quattron television is available, using a different way of providing 3D vision. Instead of a striped polarizer and passive polarized lenses it uses time multiplexed images and active shutter glasses in order to provide different images to the left and right eye.

According to the invention, the at least four sub-pixels are arranged in two sub-rows. The two sub-rows of two adjacent pixels in 2D mode are interchanged, such that the sub-pixels on the first sub-rows of the two adjacent pixels together form one pixel in 3D mode. These pixels also have at least four sub-pixels, each having a different color. As a result, two horizontally adjacent pixels in 2D mode together form two vertically adjacent pixels in 3D mode. When using five, six or more colors, the interchanging of two sub-rows leads to similar results.

According to the invention, the stripes of polarizing material do not overlay complete pixel rows (as in the prior art), but only, single sub-rows. Each pixel row is thus overlaid by a polarizing stripe for the left eye and one for the right eye. So, instead of losing half of the vertical resolution in 3D mode, the user can still see (part of) each pixel row with both eyes. Sub-pixel rendering is used to compensate for the resulting loss of horizontal resolution (now two 2D mode pixels are required for forming one 3D mode pixel with a sub-pixel for each color). As a result, the display according to the invention provides a similar high resolution in 2D as in 3D, without having to increase the number of sub-pixels or pixels in the display. When using sub-pixel rendering, the driving voltages of the separate sub-pixels are not determined by the color of the corresponding pixel only. Also the color of a neighboring pixel is taken into account when determining the driving voltages for the separate sub-pixels, which leads to an apparent increase of resolution.

The use of a fourth color makes it possible to add a sub-pixel with a large contribution to the luminance of the pixel. In an RGB pixel, the total luminance is determined by the formula 0.2126 R+0.7152 G+0.0722 B. The contribution of the green (G) sub-pixel to the luminance is considerably larger than the contribution of the red (R) and blue (B) sub-pixels. The green sub-pixel looks much brighter than the red and blue ones. When adding a fourth color with a similar large contribution to the pixel luminance, e.g. white (W), yellow (Y) or cyan (C), the pixel may be addressed such that it will be perceived as two separate pixels. The combination of sub-pixel rendering and multiple sub-pixels with a high luminance contribution improves the effect of the perceived increase of resolution.

It is to be noted, that the inventive display configuration may also be obtained using a vertically striped polarizer and pixels with two sub-columns of sub-pixels. In such an embodiment, the sub-columns of two vertically adjacent pixels should be interchanged. In 3D mode, the horizontal resolution will not be reduced. Sub-pixel rendering is used to compensate for a loss in vertical resolution. In the following, mainly embodiments using a horizontally striped polarizer are described.

The two brightest sub-pixels of the at least four sub-pixels are preferably provided in different sub-rows. When switching from 2D mode to 3D mode, the two brightest sub-pixels are then divided over the left and right side of the left-eye and right-eye pixels. If both brightest sub-pixels would be at the same side of the pixels in 3D mode, the sub-pixel rendering would be less effective.

For further improvement of the sub-pixel rendering, the two brightest sub-pixels are preferably provided in the same sub-column. As a result, the pixels formed in 3D mode will always have at least one less bright sub-pixel between the two brightest sub-pixels.

These and other aspects of the invention are apparent from and will be elucidated with reference to the embodiments described hereinafter.

### BRIEF DESCRIPTION OF THE DRAWINGS

In the drawings:

FIG. 1 shows a striped polarizer based 3D display,

FIG. 2 shows four pixels in a prior art striped polarizer based 3D display,

FIGS. 3a and 3b show how the four pixels of FIG. 2 are used in 2D and 3D mode,

FIG. 4 shows four pixels in a striped polarizer based 3D display according to the invention,

FIG. 5a shows how the pixels of FIG. 4 are used in 3D mode, without sub-pixel rendering,

FIG. 5b shows how the pixels of FIG. 4 are used in 3D mode, with sub-pixel rendering,

FIG. 6 shows a six sub-pixels version of four pixels in a display according to the invention, and

FIG. 7 shows a five sub-pixels version of four pixels in a display according to the invention.

### DETAILED DESCRIPTION OF THE INVENTION

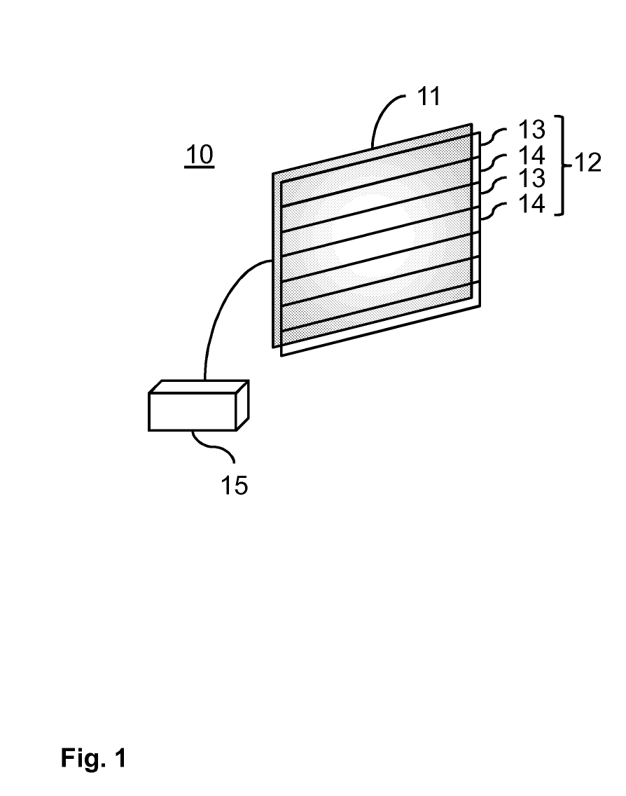

FIG. 1 shows a striped polarizer based 3D display 10. The display 10 comprises a display panel 11 with a plurality of systematically arranged pixels. The display panel 11 may, e.g., be a liquid crystal (LC) panel, a large array with LEDs of different colors or an OLED display. On top of the display panel a striped polarizer 12 is provided. The striped polarizer 12 comprises stripes 13, 14 of polarizing material, overlaying the pixel array. The polarizing material is transparent for letting through the light from the display panel 11. The striped polarizer 12 comprises an alternating pattern of left eye stripes 13 and right eye stripes 14.

Each stripe 13, 14 of polarizing material converts the incoming light from the display panel 11 to light with a well-defined polarization state. The polarization states may, e.g., be different linear or different circular polarization states. The left eye stripes 13 convert the light to a different polarization than the right eye stripe. A user watching the 3D television 10 wears glasses with different polarization filters for the left and the right eye. As a result, the user only observes light converted by the left eye stripe 13 with his left eye and light converted by the right eye stripe 14 with his right eye. The pixels underneath the right eye stripes 13 thus provide an image to the right eye. The pixels underneath the left eye stripes 14 provide an image to the left eye. To obtain a 3D view, different images are offered to the different eyes. Both images show the same scene, but from a slightly different viewpoint. In the user's brain this stereoscopic pair of images is combined which provides a 3D perception.

A display controller 15 is coupled to the display panel 11 in order to control a light output of the individual pixels in accordance with the images to be displayed. The display 10 is preferably arranged to be used in either 2D or 3D mode. In 2D mode, the user sees the light from all pixels with both eyes. The display controller 15 controls the display panel 11 to show one image at a time. In 3D mode, the user only sees half of the pixels with his left eye and the other half of the pixels with his right eye. In the 3D mode, the display controller 15 thus shows separate images for the left and right eye simultaneously.

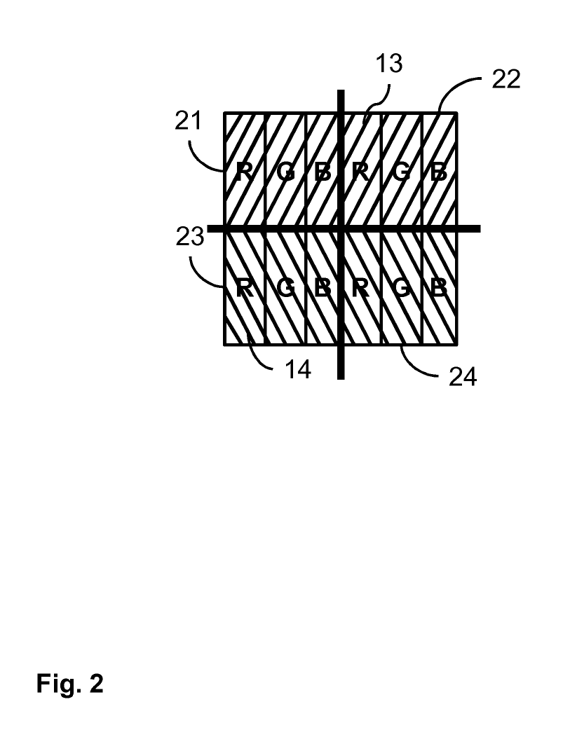

FIG. 2 shows four pixels 21, 22, 23, 24 in a prior art striped polarizer based 3D display 10. The pixels 21, 22, 23, 24 are arranged in rows and columns. Each pixel 21, 22, 23, 24 comprises three sub-pixels. Each sub-pixel is provided for emitting light of a different color. In this example, the sub-pixels are arranged to emit light in the colors red (R), green (G) and blue (B) respectively. The display controller 15 is arranged to control the intensity of the emitted light of the separate sub-pixels. The combination of red, green and blue light from the sub-pixels results in a combined color for the pixel 21, 22, 23, 24 as a whole. The striped polarizer 12 is aligned with the display panel 11, such that the left eye stripe 13 lies on top of a first row of pixels 21, 22 and the right eye stripe 14 lies on top of the adjacent second row of pixels 23, 24.

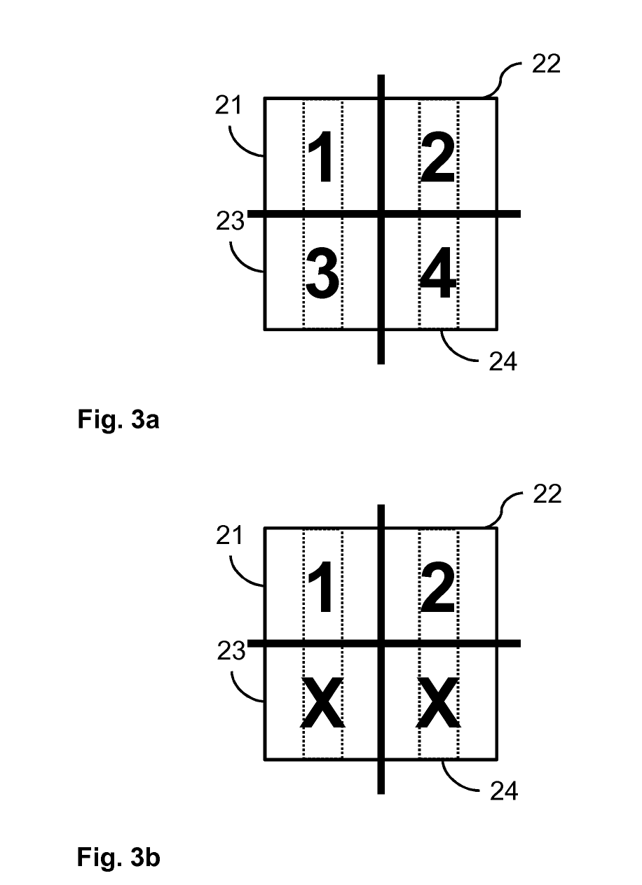

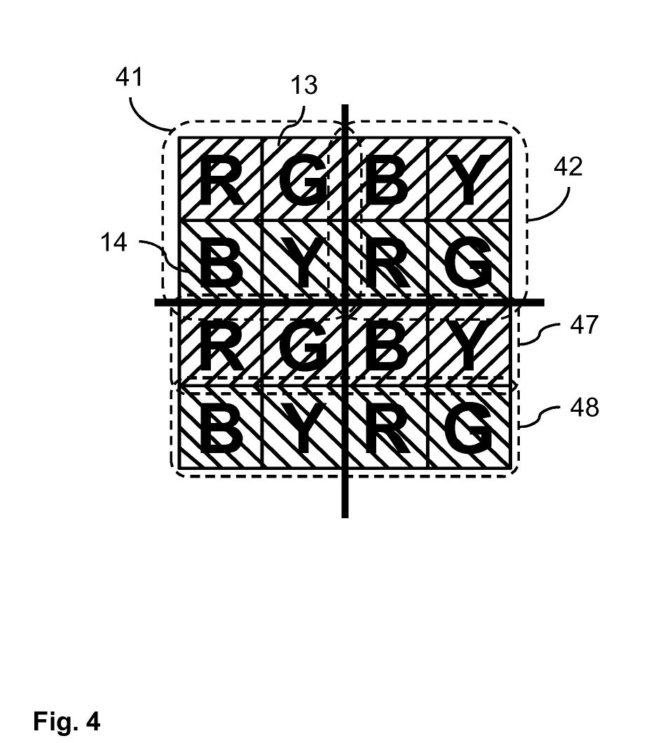

FIGS. 3a and 3b show how the four pixels 21, 22, 23, 24 of FIG. 2 are used in 2D and 3D mode. In 2D mode (FIG. 3a), the light from all four pixels 21, 22, 23, 24 is visible to both eyes of the user. Each pixel 21, 22, 23, 24 has its own color, which is produced by providing a specific mix of red, green and blue. In 3D mode (FIG. 3B), the striped polarizer 12 causes the left eye to see the light from one row of pixels 21, 22 only. The light from the pixels 23, 24 underneath the right eye stripe 14 is not visible to the left eye. As a result, in 3D mode, the images shown on the display 10 do have the same horizontal resolution as the images shown in 2D mode, but the vertical resolution in 3D mode is only half the vertical resolution in 2D mode. This problem is solved by the display arrangements discussed below with reference to FIGS. 4 to 7.

FIG. 4 shows four pixels 41, 42 in a striped polarizer based 3D display 10 according to the invention. One of the differences between the sub-pixel arrangement in FIG. 4 compared to FIG. 2 is that the sub-pixels use four instead of three sub-pixels. In addition to the RGB sub-pixels of FIG. 2, the sub-pixels of FIG. 4 also comprise a yellow (Y) sub-pixel. Alternatively, the RGB sub-pixels may be supplemented with a white (W) or cyan (C) sub-pixel. Another difference with the prior art example of FIG. 2 is in the spatial arrangement of the sub-pixels. According to the invention, the sub-pixels are arranged in a 2 by 2 quad arrangement and not in one row with three or four adjacent sub-pixels.

The left eye stripe 13 and the right eye stripe 14 of the striped polarizer 12 are now overlaying only one sub-row with sub-pixels instead of a complete row of pixels 41, 42. According to the invention, the at least four sub-pixels are arranged in two sub-rows. In one pixel 41, the first sub-row comprises the sub-pixels RG and the second sub-row comprises the pixels BY. In an adjacent pixel 42, the first sub-row comprises the sub-pixels BY and the second sub-row comprises the sub-pixels RG. The two sub-rows of the two adjacent pixels 41, 42 are thus interchanged, such that the sub-pixels on the first sub-rows of the two adjacent pixels 41, 42 in 2D mode together form one RGBY pixel 47 in 3D mode. The second rows of sub-pixels together form a second pixel 48 with the same colors BYRG.

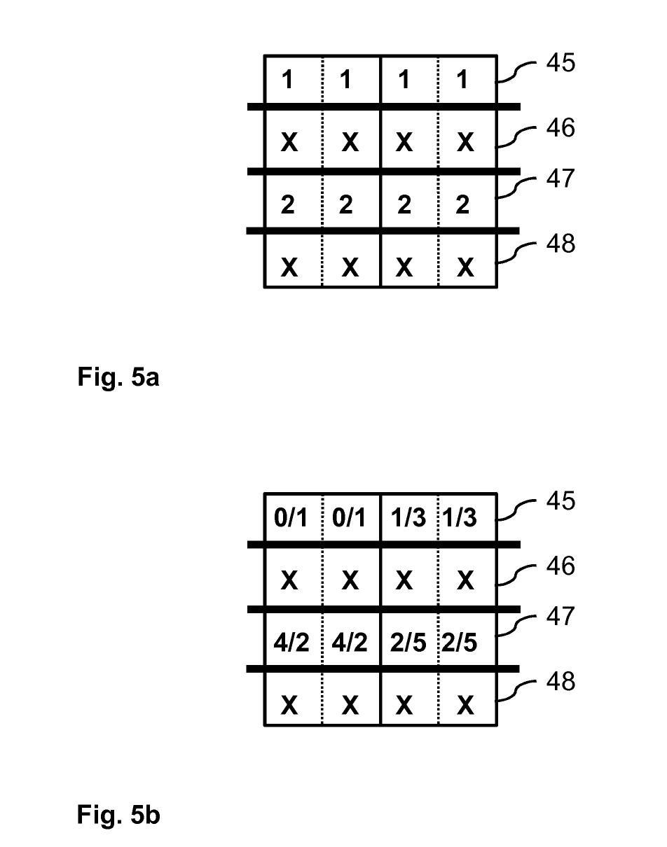

In 2D mode, the new sub-pixel arrangement does not have a big effect on the display output. The sixteen sub-pixels in FIG. 4 together form four pixels 41, 42 in a 2 by 2 arrangement. Like shown in FIG. 3a, the four pixels 41, 42 together show part of a 2D image. In 3D mode, however, things are different. FIGS. 5a and 5b shows how the pixels of FIG. 4 are used in 3D mode. Both figures illustrate what is seen by one of the user's eyes. The left eye only sees the light from the sub-pixels underneath the left eye stripe 13. The visible sub-pixels together form two RGBY pixels 45, 47. The other two pixels 46, 48 are only visible by the right eye. The vertical resolution of the image seen by one of the eyes thus is the same as in 2D mode (see FIG. 3a). From FIG. 5a it is clear, however, that without any further measures, the horizontal resolution in 3D mode would be only half the horizontal resolution in 2D mode. According to the invention, this problem is solved using sub-pixel rendering.

FIG. 5b shows how sub-pixel rendering may be used for the pixels 45, 47 of FIG. 4. With sub-pixel rendering, the display controller 15 does not only address the separate pixels, but also the separate sub-pixels. The driving voltages for the separate sub-pixels are not determined by the color of the corresponding pixel only. Also the color of a neighboring pixel is taken into account when determining the driving voltages for the separate sub-pixels. The driving voltages for the sub-pixels of the pixel 45 on the first sub-row depend on the color value for a corresponding position ‘1’ in the image to be displayed and on the color values for the positions ‘0’ and ‘3’ at the left and right side of this position ‘1’. This leads to an apparent increase of resolution. Thus, without increasing the number of sub-pixels in the display layer 11, both the vertical and the horizontal resolution can be maintained when switching from 2D mode to 3D mode.

The exact position of the different colors in the pixels 41, 42 may be chosen differently. For example, a GR-YB arrangement (first sub-row GR, second sub-row YB) for one pixel 41 and an YB-GR arrangement for the adjacent one would provide the same results. Also a BG-RY or GB-YR arrangement would be very suitable. The green and yellow sub-pixels are preferably not in the same sub-row and adjacent to each other, because those colors are brighter than the red and blue ones. For an optimal effect of the sub-pixel rendering it is preferred that these brighter pixels are evenly distributed over the display layer 11.

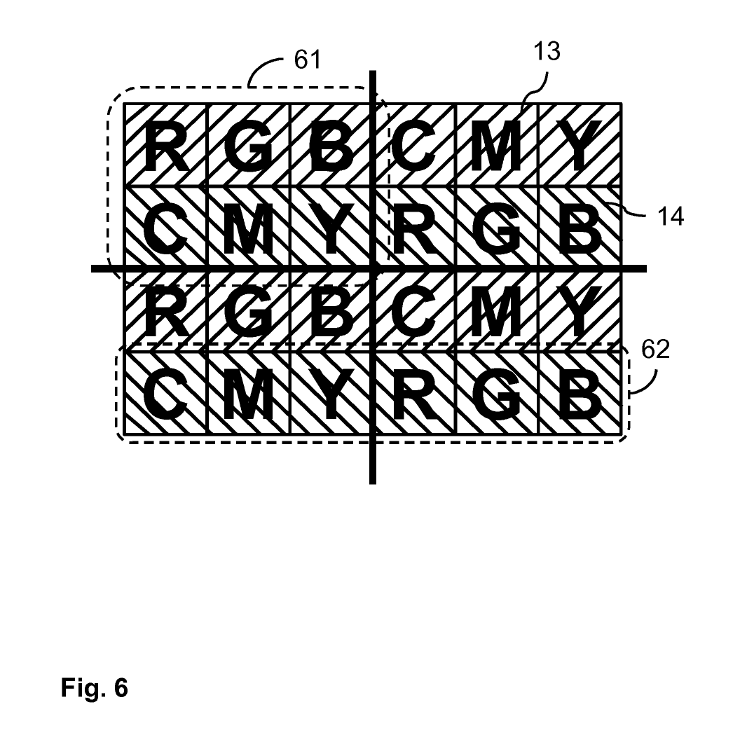

When using five, six or more colors, the interchanging of two sub-rows leads to similar results. FIG. 6 shows a six sub-pixels version of four pixels 61 in a display 10 according to the invention. The four sub-pixels of the embodiment shown in FIG. 4 are now supplemented with a cyan (C) and magenta (M) sub-pixel. Other colors and/or other sub-pixel arrangements may also be used.

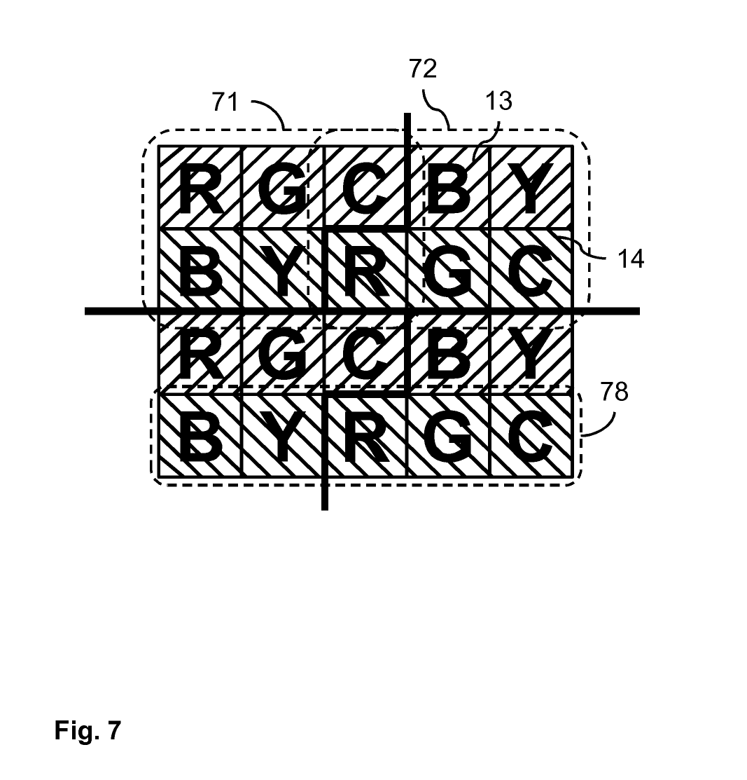

FIG. 7 shows a five sub-pixels version of four pixels 71, 72 in a display 10 according to the invention. Here the first sub-row and the second sub-row of a pixel 71 do not have the same number of sub-pixels. A first sub-row has three sub-pixels with the colors RGC, a second sub-row with two sub-pixels comprises the colors BY. In this example, two adjacent pixels 71, 72 are nested together resulting in the toothed pattern shown in FIG. 7. Alternatively, the sub-pixels in the sub-row with only two sub-pixels may be made wider or placed further apart.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A pixel based 3D display comprising:
a display panel with a plurality of pixels (41, 42) arranged in rows and columns, each pixel (41, 42) comprising at least four sub-pixels having different colors, the sub-pixels being arranged in two sub-rows and at least two sub-columns,
a first pixel (41) having
a first and a second of the at least four sub-pixels being on a first of the two sub-rows and having a first color and a second color respectively, and
a third and a fourth of the at least four sub-pixels being on a second of the two sub-rows and having a third color and fourth color respectively; and
the first pixel having an adjacent pixel (42) in the same row, comprising
a first and a second of at least four sub-pixels being on the second of the two sub-rows and having the first color and the second color respectively, and
a third and a fourth of the at least four sub-pixels being on the first of the two sub-rows and having the third color and the fourth color respectively; and
a striped polarizer overlaying the display panel and comprising stripes of transparent polarizing material, the stripes being arranged in an alternating pattern of left eye stripes and right eye stripes, wherein the left eye stripes are arranged for converting light to a first polarization and are overlaying one sub-row of the two sub-rows and wherein the right eye stripes are arranged for converting light to a different second polarization and are overlaying the other sub-row of the two sub-rows, and
a display controller for using sub-pixel rendering for controlling a light output of the pixels in accordance with a 3D image to be displayed.

2. A pixel based 3D display as claimed in claim 1, wherein the two sub-pixels with the highest contribution to the pixel's luminance of the at least four sub-pixels are provided in different sub-rows.

3. A pixel based 3D display as claimed in claim 2, wherein the two sub-pixels with the highest contribution to the pixel's luminance of the at least four sub-pixels are provided in the same sub-column.

4. A pixel based 3D display as claimed in claim 1, wherein three of the at least four sub-pixels have the colors red, green and blue and a fourth sub-pixel of the at least four sub-pixels has the color yellow, white or cyan.

5. A pixel based 3D display as claimed in claim 1, wherein each pixel (61) comprises six sub-pixels having the colors red, green, blue, yellow, cyan and magenta.

6. A pixel based 3D display as claimed in claim 1, wherein each pixel (71, 72) comprises five sub-pixels having the colors red, green, blue, yellow and cyan.

7. A pixel based 3D display as claimed in claim 6, one sub-row of the two sub-rows comprising three sub-pixels, the other sub-row of the two sub-rows comprising two sub-pixels.
